(19) United States
(12) Patent Application Publication
(10) Pub. No.: US 2012/0177714 A1
(43) Pub. Date: Jul. 12, 2012

(54) Floor mat for life

(76) Inventors: Philip Khoury, Montvale, NJ (US); Philip Brent Hover, Weston, CT (US)

(21) Appl. No.: 12/930,566

(22) Filed: Jan. 11, 2011

(51) Int. Cl. A01N 25/00; A01P 1/00

(52) U.S. Cl. 424/411

(57) ABSTRACT

The invention, herein named Floor Mat for Life, relates to a mat, (FIG. 1) composed of either fabric, paper or other substrate, impregnated with antiseptic, antibiotic, germicidal, anti-viral and/or sanitary chemical compounds (hereafter “disinfectant compounds”). The mat, placed upon a horizontal surface, would provide an active, defensive barrier to the spread of germs and/or environmental contaminants. For example, to cover the floor before and/or partially surrounding a toilet thereby protecting the toilet users' shoes and clothing from contaminants, urine or feces.

The underlying substrate may be either disposable (possibly biodegradable) or reusable (capable of cleaning and re-charging with the aforementioned disinfectant compounds). The mat could be provided in various sizes, colors, with or without images, patterns or printed messages.

The use of this device would benefits the user and society in general by eliminating, minimizing and/or containing major sources of environmental contamination, the spread of disease and illness.

### FIELD OF THE INVENTION

The following invention relates to surface mat products, and more particularly, though not exclusively, to a floor mat to be impregnated with antiseptic, antibiotic, germicidal, anti-viral and/or sanitary chemical compounds to reduce, minimize or eliminate the spread of septic, biotic, germ, viral, etc. contaminants.

### PRIOR ART

Known floor mat of the type used at a door threshold or entryway, or a bathroom floor mat. The products currently being manufactured have the limitation of collecting water/dampness from the bottom of shoes/feet and/or to remove some surface dirt from the same. It is a disadvantage of such known mats that the same are not germicidal, anti-viral, antibiotic, antiseptic, etc. These mats provide little or no protection from the spread of disease and environmental contaminants.

### OBJECT OF THE INVENTION

It is the object of the present invention to prevent the (1) introduction and (2) spread of (3) disease, (4) germs, (5) viruses and (6) environmental contaminants throughout the home, offices buildings, business establishments, hospitals, doctors' offices, other medical facilities, school buildings, restaurants, food stores, retail stores and malls, factories, government buildings, sports stadiums, arenas, health clubs, mass transit hubs, such as airports, train and bus stations, and other places of public assembly or high pedestrian traffic, etc. The use of this product will provide (7) an active, defensive, disinfectant barrier to protect the occupants of the facility, their visitors, customers, clients, patrons, patients, employees and society at large. It will (8) decrease the potential for illness to the user; (9) benefit society by reducing health care costs.

### DISCLOSURE OF THE INVENTION

There is disclosed herein a floor mat, either disposable or reusable, having impregnated therein a variety of antiseptic, antibiotic, germicidal, anti-viral and/or sanitary chemical compounds. The subject disinfectant mat invention can be manufactured in a variety of sizes, colors and patterns for aesthetic applications. The subject disinfectant mat itself is substantially more effective than conventional floor mats typically found in use in society.

The subject disinfectant mat would typically allow the user to emplace the same upon a floor or other horizontal surface to provide an active, defensive, disinfectant barrier against germs, viruses, disease, etc.

### ADVANTAGES OF THE INVENTION

1. Users of the subject invention would prevent the spread of germs, viruses, disease, fecal matter, urine and other noxious substances from the area surrounding a toilet and/or urinal. Presently, there is no barrier between the infected area and either the sole of one's shoes or one's clothing if sitting upon a toilet. Presently, clothing comes into contact with a contaminated floor area thereby becoming contaminated and serving as a means of spreading that contamination from the bathroom area to any other areas where one walks or upon which one should sit. Contaminated clothing can spread germs, viruses and disease as effectively as an unwashed hand.
2. The subject invention would be suitable for use in myriad areas other than the bathroom for example, as a doormat the invention would sanitize the shoes of the entrant eliminating germs, viruses, disease carried thereon constituting a health hazard. The user would merely walk or stand upon the subject invention to disinfect one's shoes.
3. The subject invention could serve as a disinfecting barrier surrounding pet food and water bowls to eliminate/reduce the spread of any contaminants through the home.
4. The subject invention could be used as a mat onto which a party would place her/his shoes for disinfection during a period when the latter were not being worn.
5. Similarly, the subject invention could be used as a protective barrier on countertops to receive food shopping bags which have contaminants upon their bottom surface. The exterior surfaces of food store shopping bags are contaminated either in the food store, while in a food store shopping cart, in the truck of the shopper's vehicle or on the floor of the shopper's vehicle during the transport from the food store to the home. Once carried into the home, such bags are commonly placed upon tables, counters or other horizontal surfaces for unpacking. These surfaces become contaminated through contact with the bags. The subject invention would serve as a barrier to receive the contaminated bags and protect from germs, viruses, disease, etc. during unpacking.
6. The subject invention could protect from contamination of surfaces in medical offices from examination tables, to waiting room seating, etc. Any surface could be covered with the product to serve as a germ/virus/dirt and disinfectant barrier.
7. The invention could be made in a variety of sizes.
8. The invention could be made in a variety of colors.
9. The invention could be made in a variety of patterns.
10. The invention could be made with a variety of images and/or photos thereon.
11. The invention could be made in a variety of textures to reduce or eliminate slipping.
12. The invention could be made with suitable words imprinted thereon such as “welcome”, “thank you” or any message deemed suitable for marketing to the general public.
13. The subject invention would provide myriad benefits to the user and to society in general by eliminating, minimizing and/or containing major sources of environmental contamination, the spread of disease and illness, and the planetary environment as a whole.
14. The subject invention could diminish the spread of innumerable diseases.
15. The subject invention could diminish the spread of innumerable viruses.
16. The subject invention could benefit society as a whole by generally reducing medical costs associated with the treatment and cure of uncounted illnesses from germs, viruses, environmental contaminants, etc.
17. The subject invention could be manufactured on bio-degradable substrate to reduce waste and therefore be environmentally friendly.
18. The subject invention could also be manufactured on a more durable, reusable surface for high-traffic areas. Applications such as this would not be suitable for a disposable version. The reusable and/or rechargeable mat would be cleaned periodically and re-infused with the antibiotic, anti-viral, anti-bacterial, anti-septic chemicals and/or compounds. In this manner, the subject invention would delay generation of waste at the end of its useful life thereby benefiting the environment.

### BRIEF DESCRIPTION. OF THE DRAWINGS

A preferred form of the present invention will now be described by way of example with reference to the accompanying drawings, wherein:

FIG. 1 is a schematic plan of the disinfectant mat.

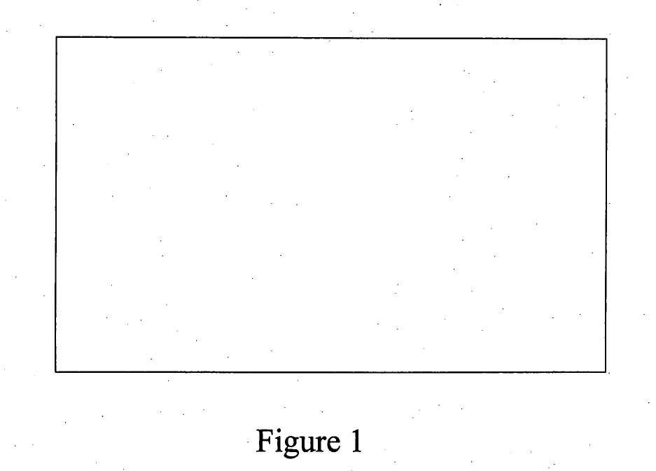

### DETAILED DESCRIPTION OF THE PREFERRED ENVIRONMENT

The present invention relates to a mat impregnated with chemical compounds, anti-biotic agents, anti-septic agents, anti-viral agents, designed to be used on a horizontal surface to be used, for example, at a door threshold, upon a table, surrounding a toilet, upon a medical examination table. In the accompanying drawings there is schematically depicted a mat generally indicated by reference numeral 1. Mat 1 comprises a single unit having impregnated thereon and therein one or more chemical compounds and/or substances which would be antibiotic, anti-viral, anti-septic in nature and function to present as a disinfectant barrier halting or diminishing the spread of germs, viruses and disease from a surface beneath the mat (e.g. floor) to another surface (e.g. a shoe sole) above the mat.

I claim:

1. A disinfectant mat impregnated with chemical compounds, anti-biotic agents, anti-septic agents, anti-viral agents, which mat would be for use upon the floor in front of and/or surrounding a toilet;

2. The disinfectant mat in claim 1 for use upon the floor beneath and in front of a urinal;

3. The disinfectant mat in claim 2 for use upon a horizontal surface above the floor such as a table or counter;

4. The disinfectant mat in claim 3 manufactured in a disposable format;

5. The disinfectant mat in claim 4 manufactured in a reusable format;

6. The disinfectant mat in claim 5 manufactured in a rechargeable format;

7. The disinfectant mat in claim 6 for use in areas where people are commonly barefoot such as going to the bathroom in the middle of the night or upon exiting from showers and bathtubs;

8. The disinfectant mat in claim 7 for use in areas where contaminants would be likely to become airborne, spread over a wider area thereby infecting more people;

9. The disinfectant mat in claim 8 for use in areas of high pedestrian traffic such as schools, sports stadiums, government offices, retail shopping malls, mass transit hubs (e.g. airports, train and bus stations);

10. The disinfectant mat in claim 9 for use in medical facilities such as hospitals, doctors' offices and examination rooms, nursing homes, assisted living facilities, emergency rooms, etc.;

11. The disinfectant mat in claim 10 for use in door thresholds in homes, businesses and offices;

12. The disinfectant mat in claim 11 which would reduce or eliminate the spread of germs;

13. The disinfectant mat in claim 12 which would reduce or eliminate the spread of viruses;

14. The disinfectant mat in claim 13 which would reduce or eliminate the spread of environmental contaminants;

15. The disinfectant mat in claim 14 which would benefit society as a whole by reducing societal health care costs;

16. The disinfectant mat in claim 14 which would benefit society by reducing employee sick time thereby diminishing productivity and harming the local, national and global economy;

17. The disinfectant mat in claim 16 which could extend lifespan by reduction of the incidence of illness;

18. The disinfectant mat in claim 17 which reduces waste at the end of its useful life when the same may be recycled.

19. The disinfectant mat in claim 18 which reduces waste by being durable, reusable and/or rechargeable thereby extending its useful life and reducing or eliminating waste;

20. The disinfectant mat in claim 19 which is aesthetic in that it can be manufactured in a variety of colors, patterns, styles, with or without imprinting and/or imagery;

21. The disinfectant mat in claim 20 which can be manufactured in a variety of textures in order to reduce slippage, for example, thereby reducing injuries.
